(19) United States
(12) Patent Application Publication
(10) Pub. No.: US 2026/0110207 A1
(43) Pub. Date: Apr. 23, 2026

(54) OMNI-CLUTCH DEVICE

(71) Applicant: STRATTEC POWER ACCESS LLC, Auburn Hills, MI (US)

(72) Inventors: Jacob Daniel Fritschle, Lake Orion, MI (US); Daniel Alexander Ney, Lake Orion, MI (US); Gregory Vance Sproule, Linden, MI (US); Paul Sebastian Crociata, Farmington Hills, MI (US); Steven Eugene Buell, Lake Orion, MI (US); Howard Warren Kuhlman, Clarkston, MI (US); David Paul Wilcox, Kingston, MI (US); Curtis Anthony Braun, Lake Orion, MI (US)

(21) Appl. No.: 19/358,607

(22) Filed: Oct. 15, 2025

Related U.S. Application Data
(60) Provisional application No. 63/708,445, filed on Oct. 17, 2024.

(51) Int. Cl. E05F 15/622; F16D 13/52

(52) U.S. Cl. CPC E05F 15/622; F16D 13/52; E05Y 2201/216; E05Y 2201/608; E05Y 2201/70; E05Y 2201/702; E05Y 2201/704; E05Y 2900/531

(57) ABSTRACT

An omni-clutch includes a rotatable input housing that rotates about an axis, and an input plate coupled to the rotatable input housing to rotate with the rotatable input housing. The device also includes an output shaft that extends through the rotatable input housing and along the axis, an output plate coupled to the output shaft to rotate with the output shaft about the axis, and a motor housing. The output shaft extends through the motor housing. The device further includes a clutch motor disposed at least partially within the motor housing, and a push housing to be moved axially along the axis via actuation of the clutch motor from a first axial position relative to the input plate and the output plate to a second axial position relative to the input plate and the output plate to impart axial force on the input plate and the output plate.

### CROSS-REFERENCE TO RELATED APPLICATIONS

This application claims priority to U.S. Provisional Application No. 63/708,445, filed Oct. 17, 2024, the entire contents of which are incorporated herein by reference.

### FIELD

This disclosure relates generally to clutch devices, and particularly to clutch devices used in powered vehicle closure systems.

### SUMMARY

In one aspect, the disclosure provides an omni-clutch device having a rotatable input housing configured to rotate about an axis, and an input plate coupled to the rotatable input housing so as to rotate with the rotatable input housing about the axis. The device also includes an output shaft that extends through the rotatable input housing and along the axis, an output plate coupled to the output shaft so as to rotate with the output shaft about the axis, and a motor housing. The output shaft extends through the motor housing. The device further includes a clutch motor disposed at least partially within the motor housing, and a push housing configured to be moved axially along the axis via actuation of the clutch motor from a first axial position relative to the input plate and the output plate to a second axial position relative to the input plate and the output plate to impart axial force on the input plate and the output plate.

In another aspect, the disclosure provides a drive system having a rotatable input housing, and a stack of input plates and output plates positioned within the rotatable input housing. The input plates are coupled to the rotatable input housing. The drive system also includes an output shaft coupled to the stack of output plates, and a push housing configured to be moved axially from a first axial position relative to the stack of input plates and output plates to a second axial position relative to the stack of input plates and output plates. The drive system also includes a drive motor coupled to the rotatable input housing, wherein the drive motor is non-back-drivable.

Other aspects of the disclosure will become apparent by consideration of the detailed description and accompanying drawings.

### BRIEF DESCRIPTION OF THE DRAWINGS

FIG. 1 is a perspective view of an omni-clutch device according to one example.

FIG. 2 is a cross-sectional view of the omni-clutch device, taken along line 2-2 in FIG. 1.

FIGS. 3A and 3B are perspective views of a rotatable input housing of the omni-clutch device.

FIG. 4 is a perspective view of an input plate of the omni-clutch device.

FIG. 5 is a perspective view of an output plate of the omni-clutch device.

FIG. 6 is a perspective view of an output shaft of the omni-clutch device.

FIG. 7 is a perspective view of an assembly operation for assembling the rotatable input housing, the input plates, the output plates, and the output shaft.

FIGS. 8A and 8B are perspective views of a motor housing for the omni-clutch device.

FIG. 9 is a perspective view of a motor drive being assembled to the motor housing.

FIGS. 10A and 10B are perspective views of a lead screw of the omni-clutch device.

FIGS. 11A and 11B are perspective views of a lead nut of the omni-clutch device.

FIGS. 12A and 12B are perspective views of a push housing of the omni-clutch device.

FIG. 13 is a perspective view of an assembly operation for assembling the push housing over the output shaft.

FIG. 14 is a perspective view of an assembly operation for assembling the lead nut and the lead screw over the output shaft.

FIG. 15 is a cross-sectional view of the omni-clutch device being used to control a power swing door on a motor vehicle.

FIG. 16 is a cross-sectional view the omni-clutch device, further including a sensor configured to measure an axial position of the push housing.

### DETAILED DESCRIPTION

Before any examples of the present disclosure are explained in detail, it is to be understood that the disclosure is not limited in its application to the details of construction and the arrangement of components set forth in the following description or illustrated in the following drawings. The disclosure is capable of other examples and of being practiced or of being carried out in various ways.

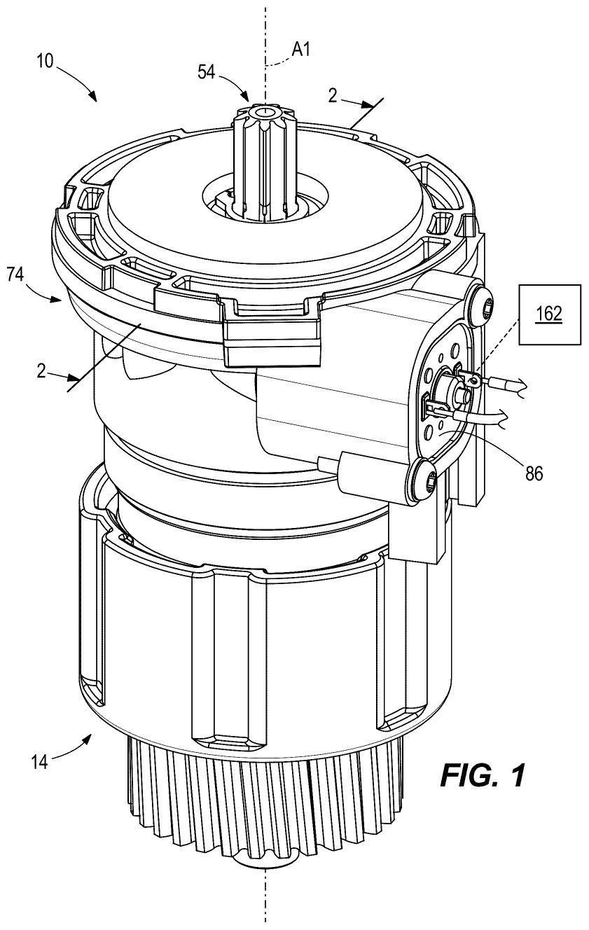

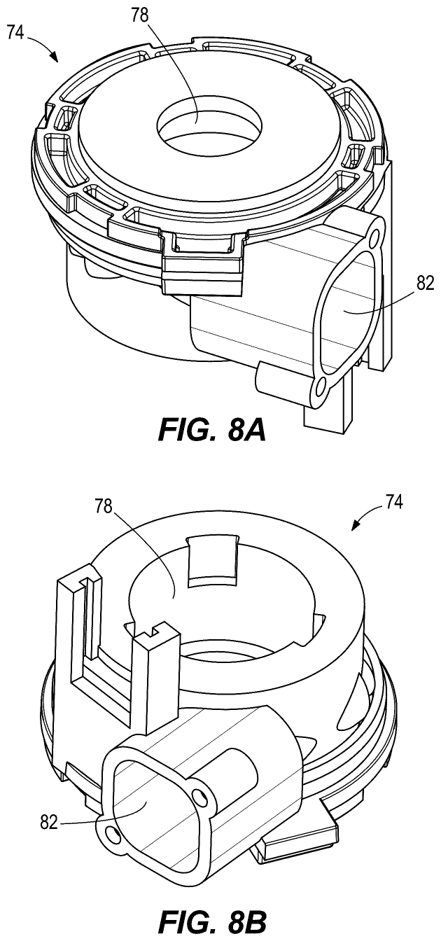

FIGS. 1-16 illustrate an omni-clutch device 10. The omni-clutch device 10 is a device that may serve not only as a clutch, but in some examples also as one or more other components. For example, and as described in further detail below, the omni-clutch device 10 may serve as one or more of a (1) clutch, (2) a slip clutch; and/or (3) a mechanical brake.

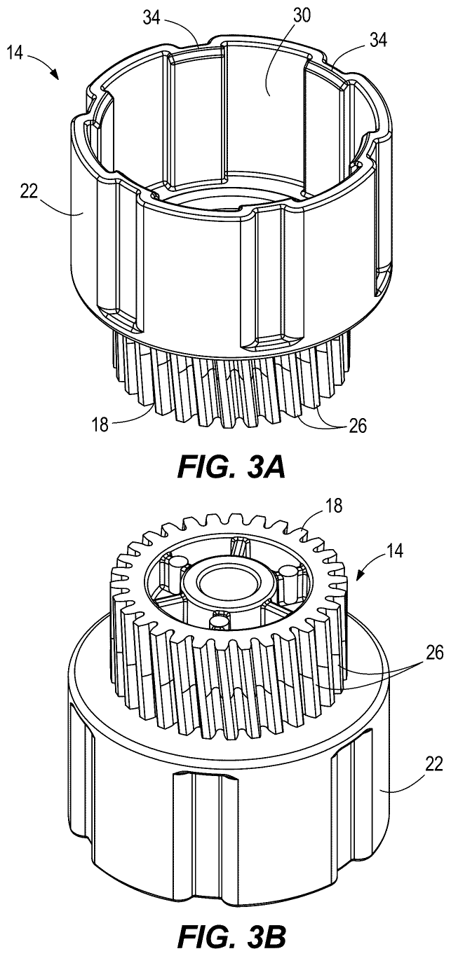

With reference to FIGS. 1-3B, the omni-clutch device 10 includes a rotatable input housing 14 configured to rotate about an axis A1 (FIG. 1). In the illustrated example, and as seen in FIGS. 3A and 3B, the rotatable input housing 14 is an inlet worm wheel having a first, geared region 18 and a second region 22 extending (e.g., axially) from the first, geared region 18. The first, geared region 18 includes a set of external gear teeth 26 configured to engage for example with a drive motor to rotate the overall rotatable input housing 14 about the axis A1. The second region 22 includes a wall defining a cavity 30. As illustrated in FIG. 3A, the wall includes a series of inward protruding portions 34 spaced circumferentially apart from one another (e.g., in a castellated pattern). Other examples of the rotatable input housing 14 may have other shapes and sizes than that illustrated, and may for example have other types of external gear teeth 26. In some examples, the rotatable input housing 14 may not have external gear teeth, and instead may have other structures (protruding outwardly or inwardly) that are engaged by a drive motor to drive rotation of the rotatable input housing. Additionally, in some examples, the rotatable housing 14 may not have inwardly protruding portions 34 arranged in a castellated pattern as shown, and instead may have other geometries and cross-sections.

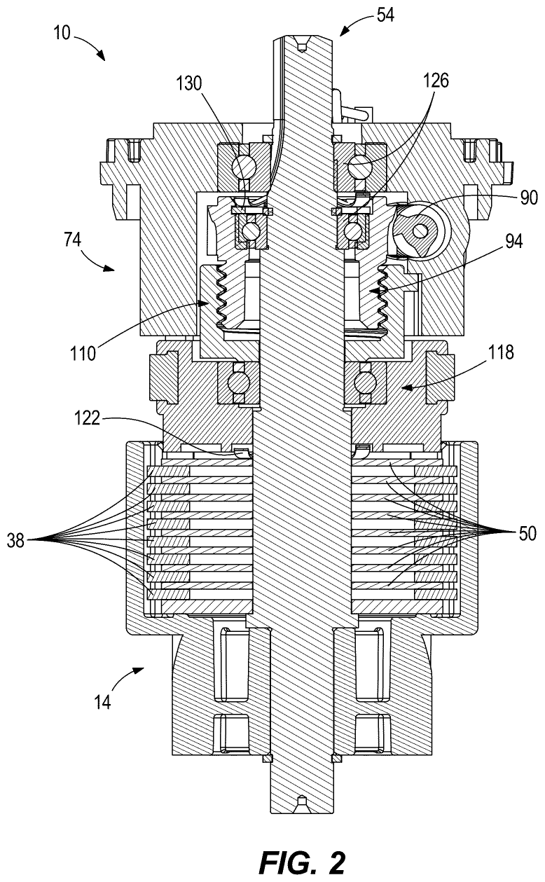

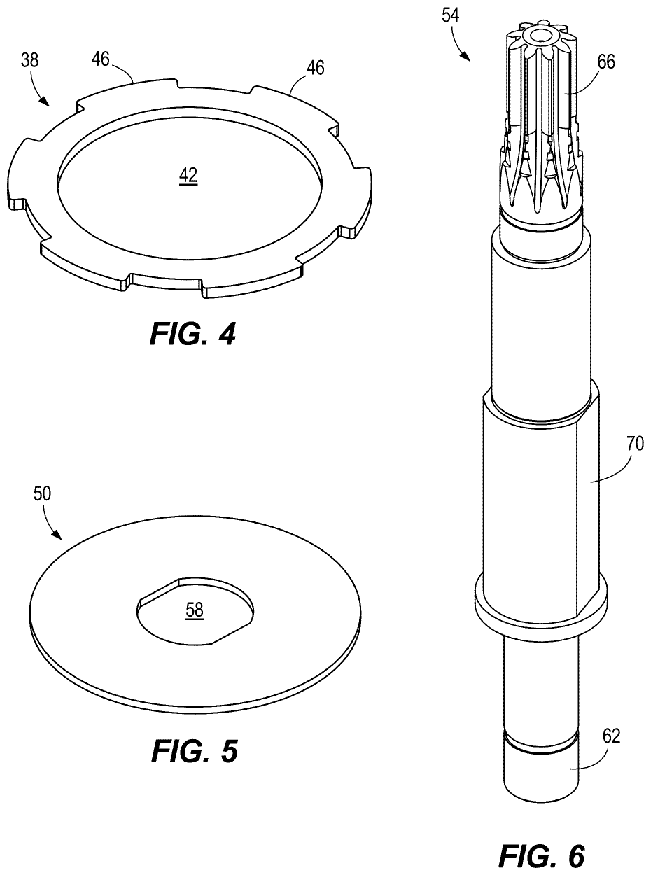

With reference to FIGS. 2 and 4, the omni-clutch device 10 may include at least one input plate 38 coupled to the rotatable input housing 14 to rotate with the rotatable input housing 14 about the axis A1. In the illustrated example, the omni-clutch device 10 includes a plurality of input plates 38. Each of the input plates 38 defines a central opening 42 (e.g., circular opening), and also a includes series of outward protruding portions 46 spaced circumferentially apart from one another (e.g., in a castellated pattern, thus defining a castellated plate). Each of the input plates 38 is configured to be positioned within the cavity 30 of the rotatable input housing 14, such that the outward protruding portions 46 are positioned between the inward protruding portions 34, and rotation of the rotatable input housing 14 drives engagement of the inward protruding portions 34 against the outward protruding portions 46 to rotate the input plates 38. In other examples, the input plates 38 may have other shapes and sizes than that illustrated, and/or other arrangements of protruding portions (e.g., protruding outwardly or inwardly) so as to engage with the rotatable housing 14 to drive co-rotation of the input plates 38 and the rotatable input housing 14.

With reference to FIGS. 1, 2, 5, and 6, the omni-clutch device 10 may include at least one output plate 50, and may also include at least one output shaft 54 that extends through the rotatable input housing 14 along the axis A1. In the illustrated example, the omni-clutch device 10 includes a plurality of output plates 50 that are each coupled to a single output shaft 54 to rotate with the output shaft 54 about the axis A1. Each of the output plates 50 is configured to be positioned within the cavity 30 of the rotatable input housing 14. Each of the output plates 50 defines a central opening 58 (e.g., non-circular opening) that is sized and shaped to slide over and/or receive the output shaft 54, such that rotation of the output shaft 54 about the axis A1 engages the output plate 50 and rotates the output plate 50 about the axis A1 within the cavity 30. In the illustrated example, the central opening 58 has a double D shape to facilitate the engagement. Other examples of the output plates 50 may include other shapes than that illustrated, or may include other features (e.g., protrusions or recesses) that engage with the output shaft 54 to facilitate co-rotation of the output shaft 54 and the output plates 50.

With reference to FIG. 6, the output shaft 54 includes a first end 62 and a second, opposite end 66. In the illustrated example, the output shaft 54 also includes a region 70 (located between the first end 62 and the second end 66) having a non-circular cross-section that corresponds in size and shape to the double D shaped central openings 58 of the output plates 50. In some examples, the second end 66 is a geared end having external gear teeth that are used, for example, to drive rotation or other movement of an external device (e.g., a power swing door, other vehicle component, or non-vehicle component).

With reference to FIG. 2, the input plates 38 and the output plates 50 may be stacked in an alternating arrangement within the cavity 30 of the rotatable input housing 14. Portions of the input plates 38 and the output plates 50 may physically contact one another and rest upon one another. In some examples, the input plates 38 are formed from a first material (e.g., a smooth, non-slip material, such as a plastics material), and the output plates 50 are formed from a second, different material (e.g., steel or other metal material). Other examples include other types of materials. In some examples, the input plates 38 and the output plates 50 are all formed from a same or similar material.

With continued reference to FIG. 2, the input plates 38 and the output plates 50 may be arranged (and be formed from materials) such that when the rotatable input housing 14 is rotated, the input plates 38 initially rotate about the axis A1 and slip relative to the output plates 50. In some examples, the input plates 38 may slip completely relative to the output plates 50, such that the output plates 50 (and the connected output shaft 54) do not rotate as the input plates 38 rotate.

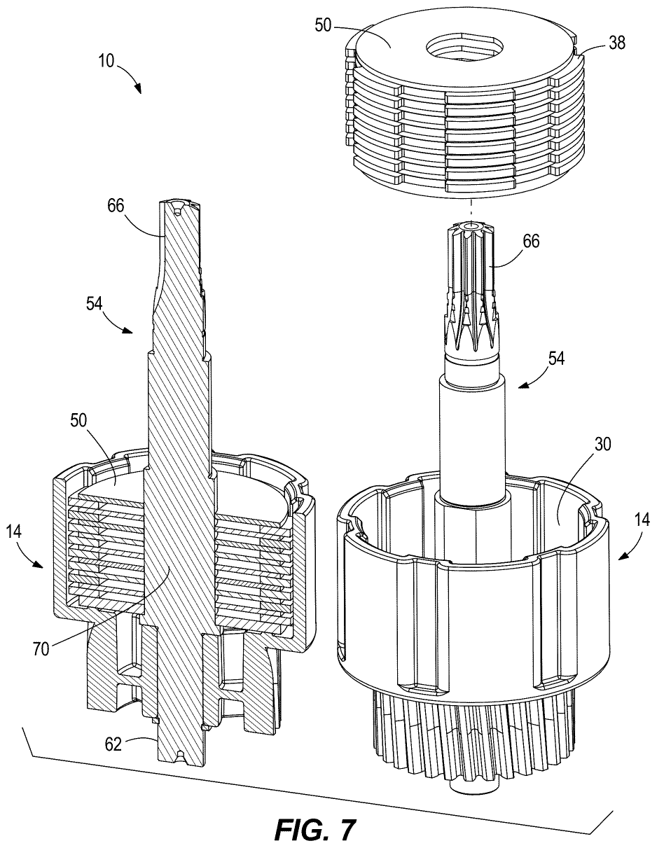

With reference to FIG. 7, assembly of the omni-clutch device 10 may include first extending the first end 62 of the output shaft 54 through the first, geared region 18 of the rotatable input housing 14. The stack of alternating input plates 38 and output plates 50 may then be extended down over the second end 66 of the output shaft 54, until the double D central openings 58 are extended over the region 70 of the output shaft 54 and the outward protruding portions 46 of the input plates 38 are positioned between the inward protruding portions 34 of the rotatable input housing 14.

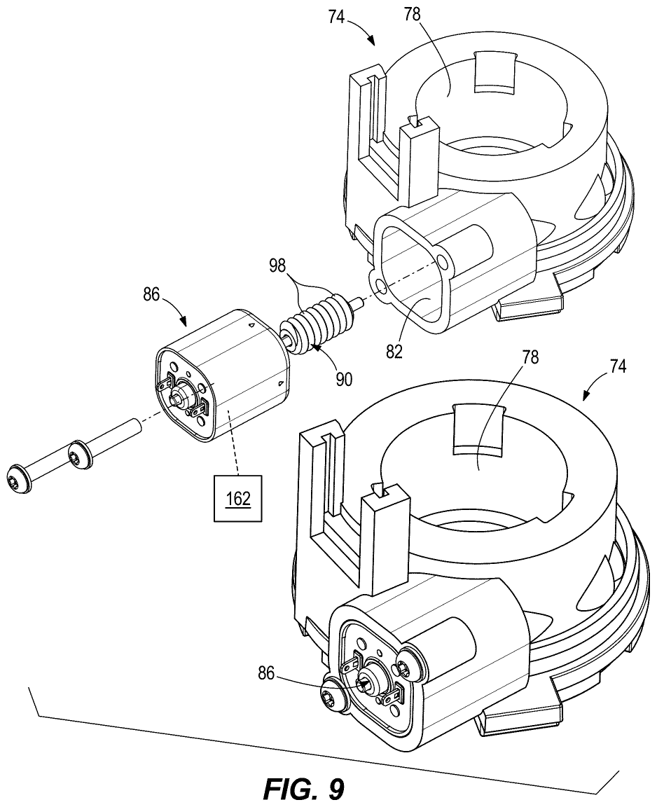

With reference to FIGS. 1, 2, 8A, 8B, and 9, the omni-clutch device 10 may include a motor housing 74. In the illustrated example, the motor housing 74 includes a central cavity 78 sized and shaped to receive the output shaft 54, such that the output shaft 54 extends axially through the motor housing 74 along the axis A1. In the illustrated example, the motor housing 74 additionally includes a secondary cavity 82 sized and shaped to receive a clutch motor 86 (FIG. 9). The clutch motor 86 is disposed at least partially within the motor housing 74, and as illustrated in FIG. 9 may be fixed to the motor housing 74, for example, via fasteners (e.g., screws, bolts, or other fasteners). The central cavity 78 may be open to the secondary cavity 82.

With continued reference to FIG. 9, in the illustrated example the clutch motor 86 includes a clutch drive 90 (e.g., a worm drive) that extends through the secondary cavity 82 and into the central cavity 78, such that the clutch drive 90 is exposed within the central cavity 78. Other examples of the omni-clutch device 10 may include various other shapes, sizes, and types of a motor housing 74 than that illustrated, and similarly may include other types and numbers of cavities and other types of clutch drives 90 than a worm drive.

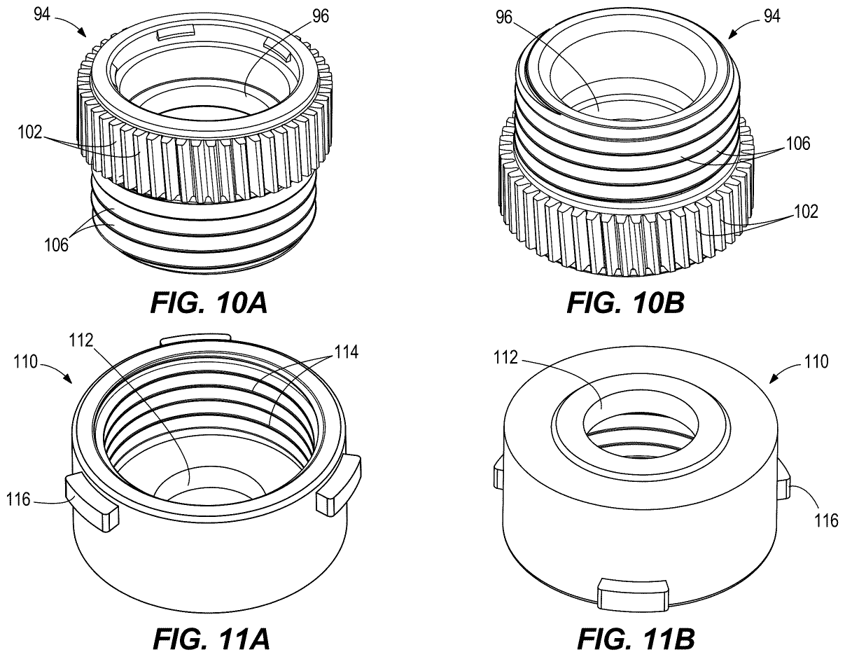

With reference to FIGS. 2, 10A, and 10B, the omni-clutch device 10 may include a lead screw 94 coupled to the clutch drive 90 and configured to be driven rotationally about the axis A1 via the clutch drive 90. In the illustrated example, the lead screw 94 includes a central opening 86. The clutch drive 90 includes a first set of external gear teeth 98 and the lead screw 94 includes a second set of external gear teeth 102 configured to be engaged by and driven by the first set of external gear teeth 98. As illustrated in FIGS. 10A and 10B, the lead screw 94 additionally includes a set of external threads 106.

With reference to FIGS. 2, 11A, and 11B, the omni-clutch device 10 may include a lead nut 110 coupled to the lead screw 94 and configured to be moved by the lead screw 94. In the illustrated example, the lead nut 110 includes a central opening 112, and a set of internal threads 114 (FIG. 11A) sized and shaped to engage the external threads 106 of the lead screw 94, such that when the clutch drive 90 rotates the lead screw 94, the lead nut 110 is forced to translate axially along the axis A1 (i.e., away from the lead screw 94 and the motor housing 74). In some examples, and as illustrated in FIGS. 11A and 11B, the lead nut 110 may include one or more flanges 116 that project outwardly and may be received in channels in the motor housing 74 (or may otherwise contact a structure or structures within the motor housing 74) to inhibit or prevent the lead nut 110 from rotating.

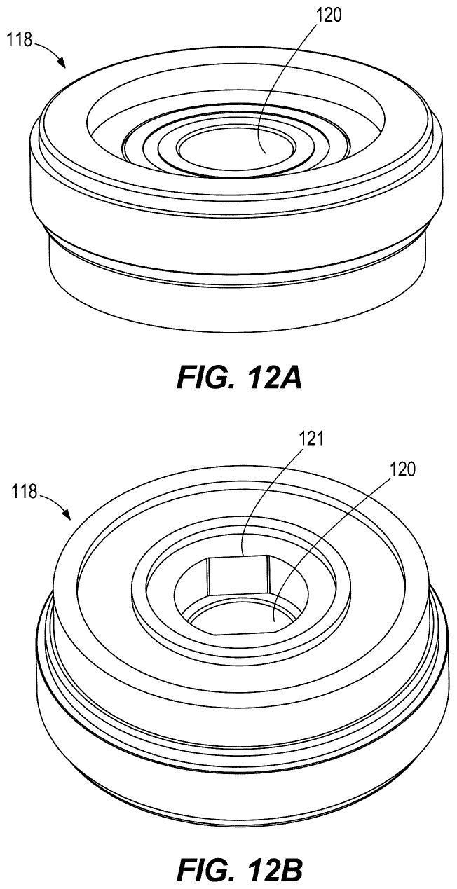

With reference to FIGS. 2, 12A, and 12B, the omni-clutch device 10 may include a push housing 118 configured to be moved axially along the axis A1 via actuation of the clutch drive 90. In the illustrated example, the push housing 118 includes a central opening 120. In some examples, the push housing 118 is rotationally coupled to the output shaft 54. For example, as illustrated in FIG. 12B, the push housing 118 may define a double D perimeter and/or formation 121 that forms part of the central opening 120 and is sized and shaped to fit over the output shaft 54 (e.g., the region 70 of the output shaft 54). In some examples, the push housing 118 may sit against one end of the lead nut 110 and/or otherwise be coupled to the lead nut 110, such that when the lead screw 94 translates, the lead nut 110 pushes the push housing 118 axially toward the stack of input plates 38 and output plates 50. The push housing 118 may therefore be moved from a first axial position relative to the stack of input plates 38 and output plates 50 to a second axial position relative to the stack of input plates 38 and output plates 50. For example, the first axial position may be a position in which the push housing 118 is spaced from (and not in physical contact with) the stack of input plates 38 and output plates 50, or a position in which the push housing 118 is simply resting on the stack of input plates 38 and output plates 50 (without pressing against the input plates 38 or output plates 38). Conversely, the second axial position may be a position in which the push housing 118 is in physical contact with and pressing with force against the stack of input plates 38 and output plates 50. When the push housing 118 is pressing against the stack of input plates 38 and output plates 50, a coefficient of friction between the input plates 38 and output plates 50 may increase. Accordingly, pressing the push housing 118 against the stack of input plates 38 and output plates 50 may cause the input plates 38 to frictionally engage the output plates 50, and thus cause the output plates 50 (and the attached output shaft 54) to rotate with the input plates 38 (e.g., with some limited slippage still occurring, or with full co-rotation and no slippage). In this manner, the omni-clutch device 10 may function as a clutch, with the clutch drive 90 acting as an actuator for controlling whether the clutch is deactivated (i.e., when the push housing 118 being spaced apart from the stack of input plates 38 and output plates 50), partially active (i.e., when the push housing 118 is pressing against the stack of input plates 38 and output plates 50 to force at least partial rotation of the output plates 50), and fully active (i.e., when the push housing 118 is pressing against the stack of input plates 38 and output plates 50 to a sufficient degree such that the output plates 50 are fully locked with the input plates 38 and are fully co-rotating with the input plates 38).

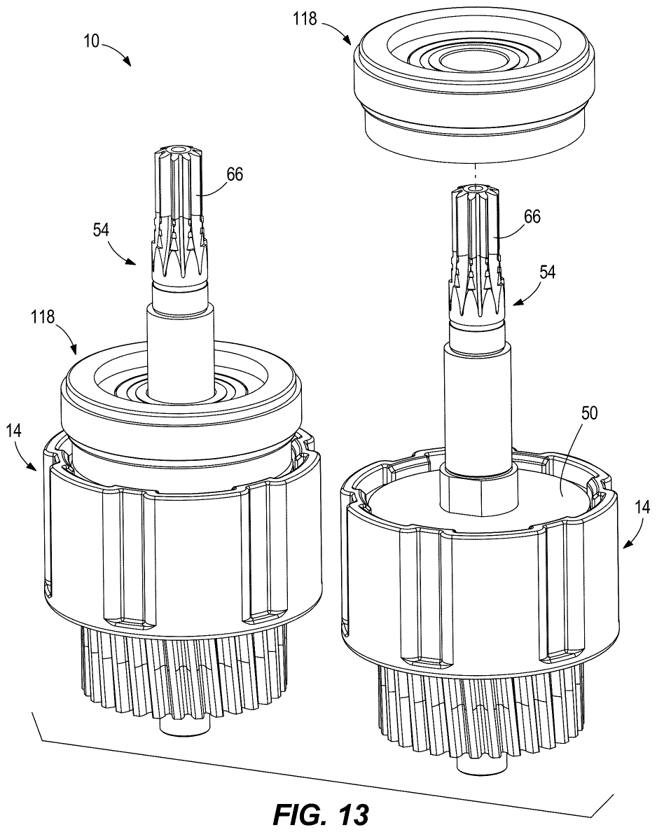

With reference to FIG. 13, assembly of the omni-clutch device 10 may include extending the push housing 118 over the second end 66 of the output shaft 54, and sliding the push housing 118 toward the stack of input plates 38 and output plates 50. As illustrated in FIG. 2, in some examples a spacer 122 (e.g., spring) may also be positioned between the push housing 118 and the stack of input plates 38 and output plates 50.

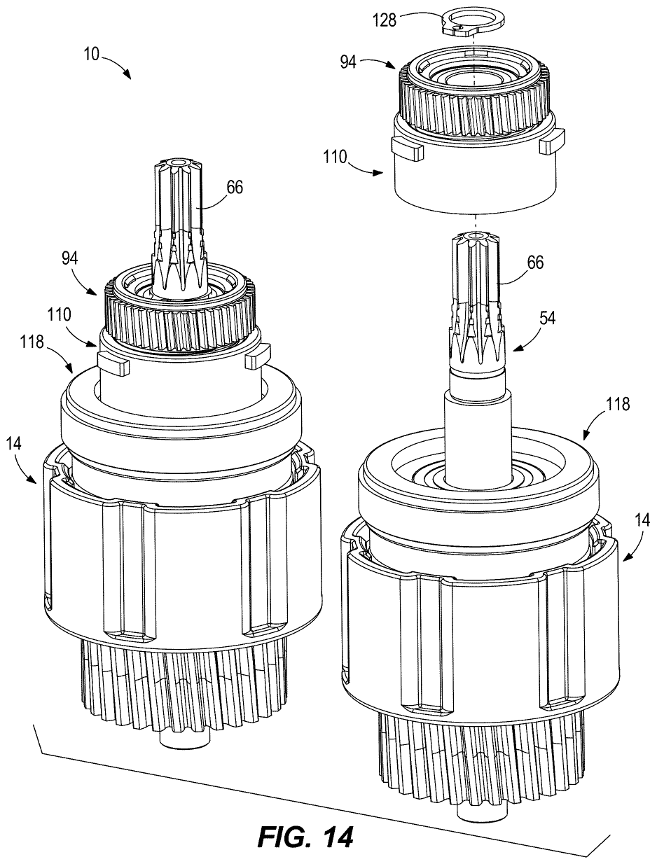

With reference to FIG. 14, once the push housing 118 has been assembled, the combined lead screw 94 and lead nut 110 may then be extended over the second end 66 of the output shaft 54, and a snap ring 128 for example may be used to secure the components in place. With reference to FIG. 2, in some examples at least one bearing 126 may also be assembled, and may be positioned partially or entirely within the motor housing 74 and/or within the lead screw 94. Another spacer 130 (e.g., spring) may be placed, for example, between one of the bearings 126 and the lead screw 94.

While the illustrated example includes the use of a clutch motor 86 having a clutch drive 90 in the form of a worm drive, along with a lead screw 94, a lead nut 110, and a push housing 118, other examples may include other components or combinations of components to achieve a similar clutching action. For example, the omni-clutch device 10 may not include a separate push housing 118. Instead, the lead nut 110 itself may function as the push housing 118, or the push housing 118 may be integrally formed as a single piece with the lead nut 110. In other examples, the clutch drive 90 may be any other types of drive (e.g., magnetic, mechanical, or otherwise) that causes axial movement of a component (e.g., the push housing 118 or other component) toward or away from the stack of input plates 38 and output plates 50, to act as a clutch.

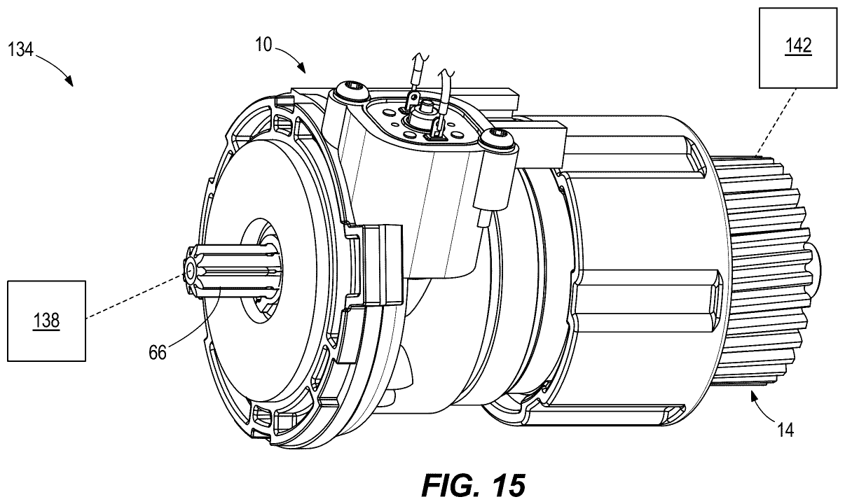

With reference to FIG. 15, and as described above, the omni-clutch device 10 may be used in a variety of different settings, including a vehicle setting. FIG. 15 schematically illustrates a drive system 134 (e.g., powered vehicle assembly) incorporating the omni-clutch device 10 for controlling a torque output 138 (e.g., for movement of a power swing door in a vehicle). As illustrated in FIG. 15, in some examples a separate drive motor 142 is coupled to the rotatable input housing 14, to generate rotational movement of the rotatable input housing 14. The drive motor 142 may be any type of motor (e.g., electric motor). The second end 66 of the output shaft 54 is coupled to the torque output 138. The torque output 138 may be any type of torque output (e.g., for automotive settings or otherwise). In some examples, the torque output 138 includes a gearbox and/or one or more output links. The drive system 134 and/or the omni-clutch device 10 may further include a housing or housings that house one or more of the components described herein.

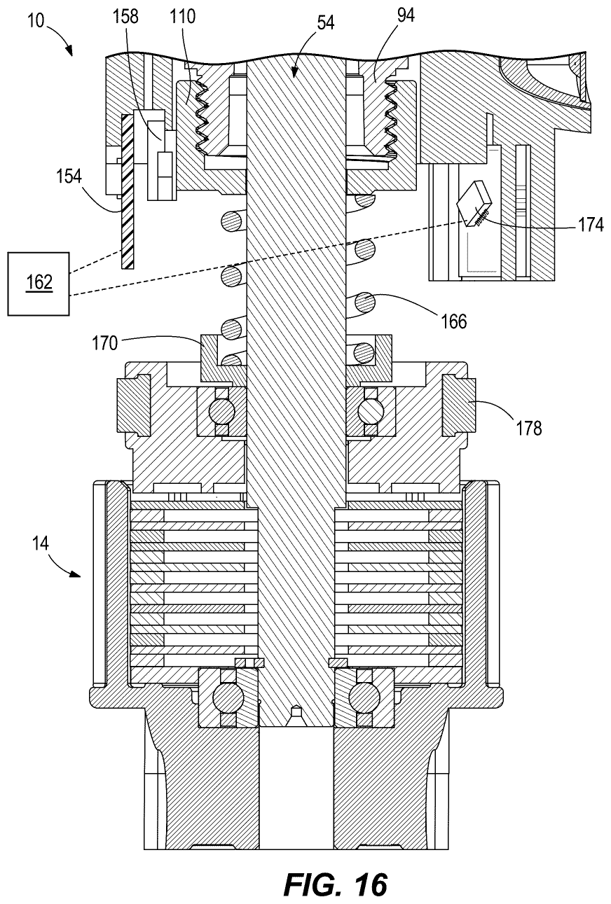

With reference to FIG. 16, in some examples the omni-clutch device 10 includes at least one sensor. In the illustrated example, the omni-clutch device 10 includes a first sensor 154 (e.g., Hall effect sensor or other type of sensor). The first sensor 154 is configured to measure one or more of (1) the position of the push housing 118; (2) the axial force being applied to (imparted on) the stack of input plates 38 and output plates 50; (3) the torque output of the omni-clutch device 10; and/or (4) the position of a component coupled to the omni-clutch device 10 (e.g., the power swing door). In the illustrated example, a first magnet 158 is coupled to the lead nut 110, and an electronic control unit 162 is coupled to the first sensor 154 (e.g., wirelessly). The electronic control unit 162 may be positioned for example on the motor housing 74 or on another component of the omni-clutch device 10, or may be located remotely. In some examples, the first sensor 154 detects the location of the first magnet 158 and sends a signal to the electronic control unit 162 (e.g., regarding an axial position of the lead nut 110 and/or the push housing 118). The electronic control unit 162 may control operation of the clutch motor 86 and as illustrated in both FIGS. 1 and 9, the electronic control unit 162 may be coupled (e.g., wirelessly) to the clutch motor 86. Accordingly, the electronic control unit 162 may send a signal to the clutch motor 86 to modify a position of the push housing 118 (e.g., to increase or decrease the force applied to the stack of input plates 38 and output plates 50, thereby increasing or decreasing the resulting torque output of the output shaft 54) based on feedback from the first sensor 154.

In some examples, and as seen in FIG. 16, a spring 166 may also be provided between the lead nut 110 and the push housing 118. A cup housing 170 may receive and hold one end of the spring 166. The spring 166 may provide a relationship between the position of the lead nut 110 and the axial force applied to the stack of input plates 38 and output plates 50, and the combination of the first sensor 154 and the first magnet 158 may make that position readable to the electronic control unit 162. Other examples may include other types and arrangements of sensors.

With continued reference to FIG. 16, in the illustrated example the omni-clutch device 10 includes a second sensor 174 (e.g., Hall effect sensor or other type of sensor). The second sensor 174 is configured to measure one or more of (1) the position of the push housing 118; (2) the axial force being applied to the stack of input plates 38 and output plates 50; (3) the torque output of the omni-clutch device 10; and/or (4) the position of a component coupled to the omni-clutch device 10 (e.g., the power swing door). In the illustrated example, a second magnet 178 (e.g., a magnet ring) is coupled to the push housing 118. The electronic control unit 162 (or a separate electronic control unit other than the electronic control unit 162) may be coupled to the second sensor 174 (e.g., wirelessly). In some examples, the second sensor 174 detects the location and/or rotational position of the second magnet 178 and sends a signal to the electronic control unit 162 (e.g., regarding an axial or rotational position of the push housing 118 and/or output shaft 54). The electronic control unit 162 may control operation of the clutch motor 86 and as illustrated in both FIGS. 1 and 9, the electronic control unit 162 may be coupled (e.g., wirelessly) to the clutch motor 86. Accordingly, the electronic control unit 162 may send a signal to the clutch motor 86 to modify a position of the push housing 118 (e.g., to increase or decrease the force applied to the stack of input plates 38 and output plates 50, thereby increasing or decreasing the resulting torque output of the output shaft 54) based on feedback from the second sensor 174.

In some examples, the omni-clutch device 10 includes only the first sensor 154 and/or the first magnet 158, and does not include the second sensor 174 and/or the second magnet 178. In other examples, the omni-clutch device 10 includes only the second sensor 174 and/or the second magnet 178, and does not include the first sensor 154 and/or the first magnet 158. In yet other examples, the omni-clutch device 10 does not include any sensors and/or magnets, or includes more than two sensors and/or magnets, or includes other arrangements of sensors than that illustrated.

With reference to FIGS. 1-16, and as described above, in some examples the omni-clutch device 10 may serve not only as a clutch, but in some examples also as one or more other components. For example, the omni-clutch device 10 may initially serve as clutch as described above. Additionally, however, the omni-clutch device 10 may also serve as a slip clutch, allowing the input plates 38 to slip relative to the output plates 50 under certain conditions. For example, if the omni-clutch device 10 is being used to control movement of a power swing door, and the push housing 118 is pressed down on the stack of input plates 38 and output plates 50, the pressure or force may not be sufficient for the output plates 50 to fully engage the input plates 38 and co-rotate with the input plates 38. Accordingly, some slippage may occur as the output plates 50 attempt to rotate with the input plates 38. Additionally, if the component (e.g., power swing door) coupled to the output shaft 54 encounters resistance (i.e., a torque or force that opposes the rotational motion of the output shaft 54), the output plates 50 may start to slip relative to the input plates 38. The omni-clutch device 10 may also serve as a mechanical brake. For example, the drive motor 142 associated with the rotatable input housing 14 may be non-back-drivable. Accordingly, when the input plates 38 are fully pressed against and engaged with the output plates 50 and the drive motor 142 is deactivated, the output shaft 54 may be inhibited or prevented from reversing direction, and the omni-clutch device 10 may serve as a mechanical brake. However, if a sufficient amount of torque or force is applied to the output shaft 54 (e.g., if a torque applied to the output shaft 54 exceeds a predetermined torque value), the full engagement of the input plates 38 and the output plates 50 may be overcome, and the input plates 38 may then begin to rotate and slip relative to the output plates 50.

Although the disclosure has been described in detail referring to certain preferred embodiments, variations and modifications exist within the scope and spirit of one or more independent aspects of the disclosure as described.

What is claimed is:

1. An omni-clutch device comprising:
a rotatable input housing configured to rotate about an axis;
an input plate coupled to the rotatable input housing so as to rotate with the rotatable input housing about the axis;
an output shaft that extends through the rotatable input housing and along the axis;
an output plate coupled to the output shaft so as to rotate with the output shaft about the axis;
a motor housing, wherein the output shaft extends through the motor housing;
a clutch motor disposed at least partially within the motor housing; and
a push housing configured to be moved axially along the axis via actuation of the clutch motor from a first axial position relative to the input plate and the output plate to a second axial position relative to the input plate and the output plate to impart axial force on the input plate and the output plate.

2. The omni-clutch device of claim 1, wherein the rotatable input housing is an inlet worm wheel, wherein the clutch motor is a first motor, and wherein the inlet worm wheel is configured to be driven rotationally via a second, separate drive motor.

3. The omni-clutch device of claim 1, wherein the input plate is a castellated plate, and wherein the output plate includes a double D shape opening configured to engage the output shaft.

4. The omni-clutch device of claim 1, wherein the input plate is one of a plurality of input plates, and wherein the output plate is one of a plurality of output plates, wherein the input plates and the output plates form a stack of alternating input plates and output plates within the rotatable input housing.

5. The omni-clutch device of claim 4, wherein the input plates are formed from a first material, and wherein the output plates are formed from a second, different material.

6. The omni-clutch device of claim 5, wherein the input plates are configured to slip rotationally relative to the plurality of output plates when the push housing is in the first axial position, and wherein the input plates are configured to frictionally engage the output plates when the push housing is in the second axial position.

7. The omni-clutch device of claim 6, wherein the output plates are configured to co-rotate with the input plates when the push housing is in the second axial position.

8. The omni-clutch device of claim 1, wherein the clutch motor includes a worm drive.

9. The omni-clutch device of claim 8, further comprising a lead screw coupled to the worm drive, wherein the lead screw is configured to be rotated via the worm drive about the axis.

10. The omni-clutch device of claim 9, further comprising a lead nut coupled to the lead screw, wherein the lead nut is configured to be moved axially along the axis via rotation of the lead screw.

11. The omni-clutch device of claim 10, wherein the lead nut is disposed between the push housing and the lead screw, and wherein the lead nut is configured to press axially against the push housing and move the push housing axially.

12. The omni-clutch device of claim 1, further comprising a sensor configured to measure an axial position of the push housing.

13. The omni-clutch device of claim 12, further comprising an electronic control unit coupled to the clutch motor to control operation of the clutch motor, wherein the sensor is configured to send a signal to the electronic control unit regarding the axial position of the push housing.

14. The omni-clutch device of claim 1, wherein the omni-clutch device is each of (1) a clutch; (2) a slip clutch; and (3) a mechanical brake.

15. A powered vehicle assembly comprising:
the omni-clutch device of claim 1;
a drive motor coupled to the rotatable input housing and configured to rotate the rotatable input housing; and
a vehicle component coupled to an end of the output shaft.

16. The powered vehicle assembly of claim 15, wherein the drive motor is non-back-drivable.

17. The powered vehicle assembly of claim 15, wherein the vehicle component is a power swing door.

18. A drive system comprising:
a rotatable input housing;
a stack of input plates and output plates positioned within the rotatable input housing, wherein the input plates are coupled to the rotatable input housing;
an output shaft coupled to the output plates;
a push housing configured to be moved axially from a first axial position relative to the stack of input plates and output plates to a second axial position relative to the stack of input plates and output plates; and
a drive motor coupled to the rotatable input housing, wherein the drive motor is non-back-drivable.

19. The drive system of claim 18, wherein the drive motor is a first motor, wherein the drive system further includes a second, clutch motor coupled to the push housing to move the push housing between the first axial position and the second axial position.

20. The drive system of claim 18, wherein when the drive motor is deactivated and a torque applied to the output shaft exceeds a predetermined torque value, the output plates are configured to slip relative to the input plates.
